(19) United States
(12) Patent Application Publication
(10) Pub. No.: US 2010/0034930 A1
(43) Pub. Date: Feb. 11, 2010

(54) Edible, Flour Based, Raised Bread Food Cup

(76) Inventor: Jae Sung Ko, Denver, CO (US)

Correspondence Address: SWANSON & BRATSCHUN, L.L.C., 8210 SOUTHPARK TERRACE, LITTLETON, CO, 80120, US

(21) Appl. No.: 12/188,270

(22) Filed: Aug. 8, 2008

(51) Int. Cl. A23G 3/54; A21D 13/00; A23L 1/31

(52) U.S. Cl. 426/90; 426/92; 426/94; 426/143

(57) ABSTRACT

The invention is directed to a food cup comprising a body formed of an edible, flour based, raised bread composition, the body comprising a bottom wall having a periphery, a sidewall extending from the periphery of the bottom wall and an opening defined by the top of the sidewall. The bottom wall and the sidewall define a cavity therein accessible by the opening, the cavity being adapted to receive and contain food. The invention is also directed to a food cup serving wherein a food cup is at least partially filled with a food filling. The invention is further directed to a food cup delivery system comprising a container comprising a plurality of receptacles, each receptacle being configured to receive a food cup such that the food cup is supported in an approximately vertical position by the receptacle. At least one food cup is provided in a receptacle, the cavity of the food cup being filled to at least partial capacity with an edible food filling.

### TECHNICAL FIELD

This invention relates to an edible, flour based, raised bread food cup adapted to receive and contain food filling thereby providing for greatly enhanced portability and facilitating automated meal assembly.

### BACKGROUND

The need for portability in food is well recognized. Surveys of motor vehicle drivers have revealed that as many as twenty-five percent of drivers are eating or drinking while driving at any given time. The importance of food portability for drivers is heightened by safety concerns that food can distract drivers from paying attention to the road. Given modern fast paced lifestyles, it appears unlikely that drivers can be convinced to avoid eating while driving. A more practical solution can be found by increasing the portability of foods to minimize the spilling and mess that pose the greatest distraction hazard of eating while driving.

The need for enhanced portability of food in heightened by the fact that the most popular foods can also be among the messiest to take on the go. Burgers and sandwiches pose the ever present risk of dirtying one's clothes particularly because these foods are commonly consumed with liquid condiments that easily squeeze out from between two pieces of bread or bun.

A further need exists to automate food preparation. In particularly busy locations such as airports, sporting events and music theaters, manual food preparation often fails to keep up with consumer demand resulting in long wait times and lost business. The automation of food preparation can also reduce the cost of the prepared foods to the consumer by decreasing the production cost. Buns and bread generally having two separate parts (slices) for the containment of the food fillings present automation problems because food contents can easily slip out from between the bun or bread slices. The incomplete containment of the food contents results in greater automation complexity.

The present invention is directed toward overcoming one or more of the problems discussed above.

### SUMMARY OF THE EMBODIMENTS

The invention is directed to a food cup comprising a body formed of an edible, flour based, raised bread composition, the body comprising a bottom wall having a periphery, a sidewall extending from the periphery of the bottom wall and an opening defined by the top of the sidewall. The bottom wall and the sidewall define a cavity therein accessible by the opening, the cavity being adapted to receive and contain food. The invention is also directed to a food cup serving wherein a food cup is at least partially filled with a food filling. The invention is further directed to a food cup delivery system comprising a container comprising a plurality of receptacles, each receptacle being configured to receive a food cup such that the food cup is supported in an approximately vertical position by the receptacle. At least one food cup is provided in a receptacle, the cavity of the food cup being filled to at least partial capacity with an edible food filling.

### BRIEF DESCRIPTION OF THE DRAWINGS

The device of the invention is illustrated in greater detail in the attached Figures, in which:

FIG. 1A-1C are perspective views of various embodiments of the food cup;

FIG. 2 is a sectional view of a food cup partially filled with food filling;

FIG. 3 is a perspective view of the food cup delivery system wherein food cups are placed into receptacles of a container; and

FIG. 4 is a plan view of the container for the food cups in an unassembled configuration.

### DETAILED DESCRIPTION

The term “condiment” is used to mean a preparation to enhance enjoyment of accompanying food including but not limited to, individually or in combination, cut vegetables, sauces, relishes and spices.

The term “cup-like” is used to mean a surface with concavity sufficient to receive a food cup such that food cup is supported in an approximately vertical position.

The term “cut-out” is used to mean that a part of the receptacle platform has been removed such that the self supporting sheet material present on the periphery of the cut-out space supports the food cup in an approximately vertical position.

The term “flap” is used to mean a portion of the self supporting sheet material amenable to folding and optionally connecting for the purpose of assembling the container of the food cup delivery system.

The term “nut flour” is used to mean flour made at least partially from almonds, hazelnuts, chestnuts, acorns or other nuts.

The term “receptacle” is used to mean the part of the container of the food cup delivery system designed to receive and contain a food cup.

The term “receptacle platform” is used to mean the part of the container of the food cup delivery system surface that comprises the receptacles as features of its surface.

The term “self supporting sheet material” is used to mean a planar material with the stiffness to maintain a three dimensional shape including but not limited to paperboard, foam, and cardboard.

The term “tapered” is used to mean gradually narrower or thinner toward one end.

The term “white flour” is used to mean flour made from only the endosperm of the wheat grain.

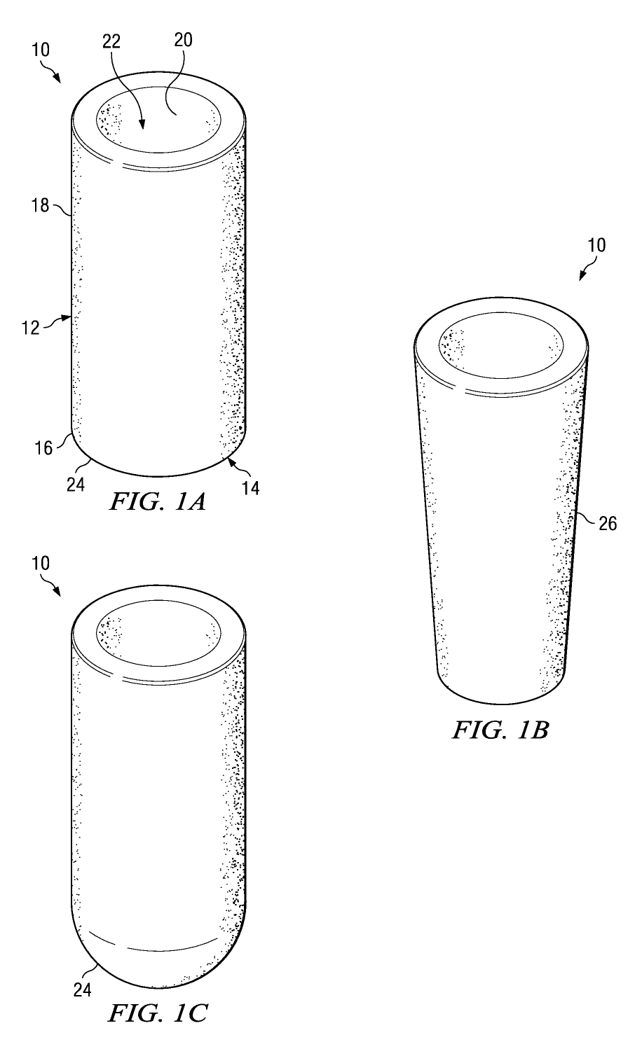

FIG. 1A depicts a food cup 10 comprising a body 12 formed of an edible, flour based, raised bread composition. The body 12 comprises a bottom wall 14 having a periphery 16 and a sidewall 18 extending from the periphery 16 of the bottom wall 14 and an opening 20 is defined by a top of the sidewall 18, the bottom wall 14 and the sidewall 18 defining a cavity 22 therein accessible by the opening 20, the cavity 22 being adapted to receive and contain food. The sidewall 18 of the food cup 10 is substantially cylindrical. The cavity 22 defined by a substantially cylindrical sidewall 18 is taller in a vertical axis than wide in a horizontal axis. The bottom wall 14 and the sidewall 18 are of substantial thickness such that the food cup is structurally self supporting, facilitating automated drop placement of food filling, manual insertion of food filling, transport in cut-out receptacles, and consumption by hand. The exterior 24 of the bottom wall 14 is flat allowing the food cup to stand upright on a horizontal surface.

A first alternative embodiment of the food cup 10 is illustrated in FIG. 1B. In the first alternative embodiment, the circumference of the exterior of sidewall 26 is tapered toward the bottom. The food cup of the first alternative embodiment would help prevent downward slippage of the food cup through a hand or a cut-out receptacle.

A second alternative embodiment of the food cup 10 is illustrated in FIG. 1C. In the second alternative embodiment, the exterior 24 of bottom wall 14 is rounded. A rounded bottom may allow for more fluids from food filling received in the cup to be absorbed by the bottom wall 14.

The food cup can comprise any of the following flours, individually or in combination: white flour, wheat flour, rye flour, spelt flour, corn flour, tapioca flour, rice flour, buckwheat flour, chestnut flour, chickpea flour, teff flour, pea flour, bean flour, potato flour, amaranth flour, arrowroot flour, taro flour, cattail flower and nut flour. The flour is raised with a raising agent, including but not limited to, yeast, baking powder and baking soda. Other ingredients used in bread making known in the art such as salt, eggs, water, etc., may be included in food cup composition. After making a desired dough, the dough is formed into a cup-like configuration and baked.

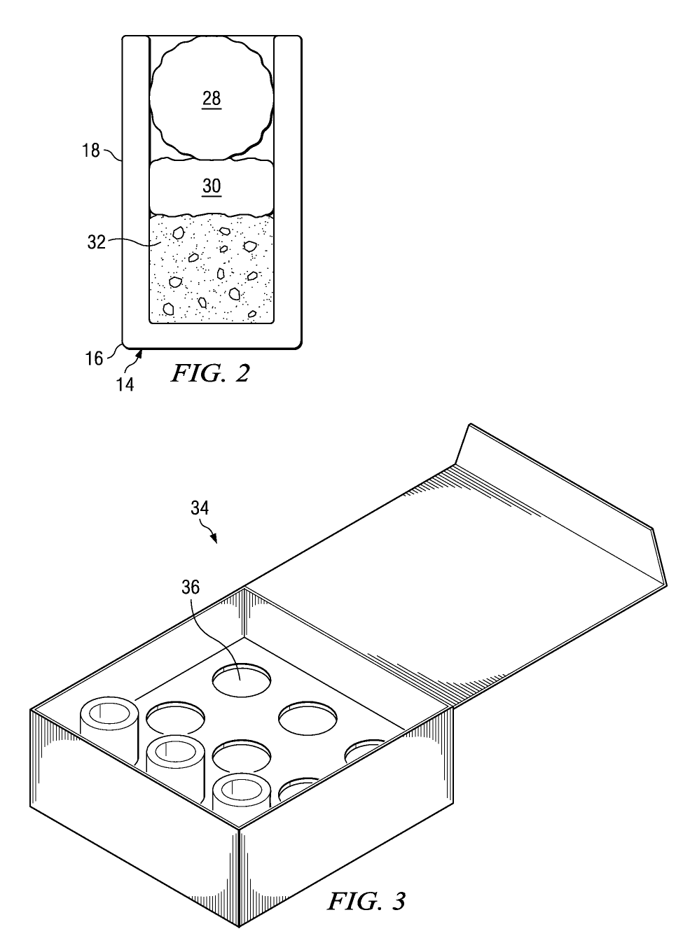

FIG. 2 depicts another aspect of the invention according to which the food cup 10 is filled to at least partial capacity with an edible food filling. The food fillings placed into food cup can be any type of food which can fit whole or in part into the interior cavity 22 of the food cup. Such food fillings include but are not limited to, individually and in combination, meat (chicken, fish, beef, pork, etc.), optionally in the form of a ball 28, cheeses of various types 30 (cheddar, Swiss, gouda, provolone, etc.), and condiments 32 of any desired variety (ketchup, mustard, relish, diced vegetables, etc.). Food fillings are received into the food cup from the opening 20 at the upper end of the body 12. The top-side opening 20 of the food cup is efficient for automated drop placement of food fillings. The food fillings may be placed in any order or mixed together.

FIG. 3 depicts a further aspect of the invention wherein the food cup 10 is a component of a food cup delivery system which includes a container 34. Container 34 comprises a plurality of receptacles 36 each receptacle being configured to receive a food cup such that the food cup is supported in an approximately vertical position by the receptacle.

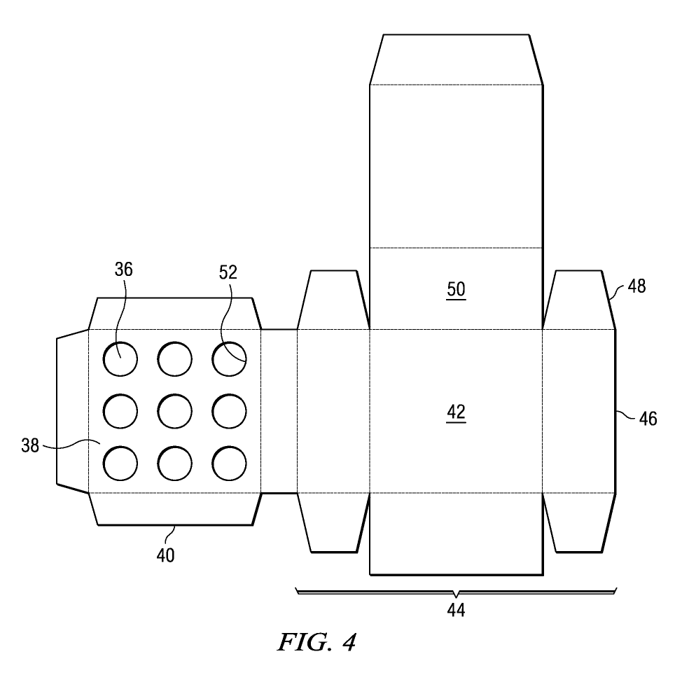

In one embodiment as depicted in FIG. 4, the container 34 is made of self supporting sheet material. A receptacle platform 38, optionally a removable section of the container, comprises flaps 40 that support the receptacle platform 38 above the base 42 of the containment box 44. One receptacle platform flap 40 may be detachably connected to containment box 44 in order to allow container 34 to be assembled from one continuous piece of self-supporting sheet material. The containment box 44 is assembled by folding flaps 46, 48 and 50 up from base 42 and connecting flaps 48 to flaps 50 in an overlapping manner. The connection may be glue, staples, interlocking tabs or any other known manner. In one embodiment, the receptacles 36 may be cut-out from the receptacle platform 38 such that the self supporting sheet material at the periphery of cut-out space 52 supports the food cup 10 in an approximately vertical position. In another embodiment, the receptacles 36 comprise self supporting sheet material in a cup-like shape such that the food cup 10 can be received and contained in the cup-like shaped receptacle 36 which conforms to the shape of the food cup.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

What is claimed is:

1. A food cup comprising: a body formed of an edible, flour based, raised bread composition,
the body comprising a bottom wall having a periphery, a sidewall extending from the periphery of the bottom wall and an opening defined by a top of the sidewall, the bottom wall and the sidewall defining a cavity therein accessible by the opening, the cavity being adapted to receive and contain food.

2. The food cup according to claim 1, wherein the sidewall is substantially cylindrical.

3. The food cup according to claim 2, wherein the cavity defined by the substantially cylindrical sidewall is taller in a vertical axis than wide in a horizontal axis.

4. The food cup according to claim 1, wherein the exterior of the bottom wall is flat to stand upright on a horizontal surface.

5. The food cup according to claim 1, wherein the exterior of the bottom wall is rounded.

6. The food cup according to claim 1, wherein the circumference of the exterior of sidewall is tapered toward the bottom.

7. The food cup according to claim 1, wherein the cavity is filled to at least partial capacity with an edible food filling.

8. The food cup according to claim 7, wherein the food filling comprises meat.

9. The food cup according to claim 7, wherein the food filling comprises layered meat, cheese and condiments.

10. The food cup according to claim 1, wherein the flour base is selected from the group consisting of white flour, wheat flour, rye flour, spelt flour, corn flour, tapioca flour, rice flour, buckwheat flour, chestnut flour, chickpea flour, teff flour, pea flour, bean flour, potato flour, amaranth flour, arrowroot flour, taro flour, cattail flower and nut flour.

11. The food cup according to claim 1, wherein the bottom wall of the food cup and the sidewall of the food cup are of sufficient thickness such that the food cup is structurally self-supporting.

12. A food cup delivery system comprising:
at least one food cup comprising a body formed of an edible, flour based, raised bread composition, the body comprising a bottom wall having a periphery, a sidewall extending from the periphery of the bottom wall and an opening defined by the top of the sidewall, the bottom wall and the sidewall defining a cavity therein accessible by the opening, the cavity being adapted to receive and contain food, the cavity being filled to at least partial capacity with an edible food filling;
a container comprising a plurality of receptacles, each receptacle being configured to receive a food cup such that the food cup is supported in an approximately vertical position by the receptacle; and
the at least one food cup being received in a receptacle.

13. The food cup delivery system according to claim 12, wherein the bottom wall of the food cup and the sidewall of the food cup are of sufficient thickness such that the food cup is structurally self-supporting.

14. The food cup delivery system according to claim 12, wherein the exterior of the bottom wall of the food cup is flat to stand upright on a horizontal surface.

15. The food cup delivery system according to claim 12, wherein the exterior of the bottom wall of the food cup is rounded.

16. The food cup delivery system according to claim 12, wherein the circumference of the exterior of the sidewall of the food cup is tapered toward the bottom.

17. The food cup delivery system according to claim 12, wherein the receptacle is a cup-like receptacle configured to receive at least a portion of the food cup

18. The food cup delivery system according to claim 12, wherein the receptacle is a cut-out receptacle configured to receive at least a portion of the food cup.

19. The food cup delivery system according to claim 17, wherein the cup-like receptacle is configured to receive and conform to the shape of the food cup wherein the exterior of the bottom wall of the food cup is selected from the group consisting of rounded and flat.

20. The food cup delivery system according to claim 17, wherein the cup-like receptacle is configured to receive and conform to the shape of the food cup wherein the circumference of the exterior of the sidewall of the food cup is tapered toward the bottom.
